(19) United States
(12) Patent Application Publication
(10) Pub. No.: US 2024/0419898 A1
(43) Pub. Date: Dec. 19, 2024

(54) TRAINING DATA AUGMENTATION DEVICE

(71) Applicant: NTT DOCOMO, INC., Tokyo (JP)

(72) Inventors: Akari INAGO, Chiyoda-ku (JP); Hiroshi FUJIMOTO, Chiyoda-ku (JP); Yuiko TSUNOMORI, Chiyoda-ku (JP)

(73) Assignee: NTT DOCOMO, INC., Tokyo (JP)

(21) Appl. No.: 18/708,707

(22) PCT Filed: Oct. 14, 2022
(86) PCT No.: PCT/JP2022/038425

§ 371 Date: May 9, 2024

(30) Foreign Application Priority Data
Nov. 16, 2021 (JP) 2021-186128

(51) Int. Cl. G06F 40/279

(52) U.S. Cl. CPC G06F 40/279

(57) ABSTRACT

A training data augmentation device (10) includes: an augmented sentence generator (11) configured to generate a plurality of augmented sentences by processing a sentence for training included in training data given in advance according to a plurality of degrees of word replacement; and an augmentation data generator (12) configured to derive a degree of association in a word pair having a dependency relationship in each augmented sentence, determine whether or not to add the augmented sentence to augmentation data for augmenting the training data for each stage based on a comparison result between an obtained degree of association and thresholds of a plurality of stages determined in advance, and generate augmentation data of a plurality of stages by an augmented sentence determined to be added.

### TECHNICAL FIELD

The present disclosure relates to a training data augmentation device that generates augmentation data for augmenting training data.

### BACKGROUND ART

In recent years, advances in artificial intelligence technologies such as deep learning have been remarkable, and in particular, artificial intelligence that discovers a certain rule from a large amount of data and realizes recognition and prediction has been known. The recognition and prediction ability of such artificial intelligence depends on the quantity and quality of training data used to train a model. Therefore, for the purpose of augmenting training data, Patent Literature 1 describes technology of generating augmentation data through processing with a plurality of degrees of augmentation for each augmentation method.

### CITATION LIST

### Patent Literature

Patent Literature 1: Japanese Unexamined Patent Publication No. 2020-140466

### SUMMARY OF INVENTION

### Technical Problem

Assuming that training data includes a plurality of sentences expressed in a certain language, when generating augmentation data thereof, for example, there is a problem in that whether or not to add a sentence, which is obtained by replacing a word in a sentence included in the training data with a different word, to the augmentation data depends on the degree of association between words. For example, with regard to a sentence “A description will be given of a stage of a certain point service.” included in training data, a sentence “A description will be given of an arena of a certain point service.” obtained by replacing a word “stage” in the sentence to another word “arena” will be considered. In this case, it is considered that a degree of association between “point service” and “stage” is high, and thus it is undesirable to replace “stage” with “arena”. For this reason, it should be determined that the sentence obtained by word replacement should not be added to augmentation data.

However, the above-described Patent Literature 1 does not mention a point to keep in mind in augmentation of training data described above, and there is a long-awaited need to appropriately generate augmentation data while considering a degree of association between words.

The disclosure has been made to solve the above problems, and an object of the disclosure is to appropriately generate augmentation data while considering a degree of association between words.

### Solution to Problem

A training data augmentation device according to the disclosure includes an augmented sentence generator configured to generate a plurality of augmented sentences by processing a sentence for training included in training data given in advance according to a plurality of degrees of word replacement, and an augmentation data generator configured to derive a degree of association in a word pair having a dependency relationship in each augmented sentence, determine whether or not to add the augmented sentence to augmentation data for augmenting the training data for each stage based on a comparison result between an obtained degree of association and thresholds of a plurality of stages determined in advance, and generate augmentation data of a plurality of stages by an augmented sentence determined to be added.

In the training data augmentation device, the augmented sentence generator generates a plurality of augmented sentences by processing a sentence for training included in training data given in advance according to a plurality of degrees of word replacement, and the augmentation data generator derives a degree of association in a word pair having a dependency relationship in each of the generated augmented sentences, determines whether or not to add the augmented sentence to augmentation data for augmenting the training data for each stage based on a comparison result between an obtained degree of association and thresholds of a plurality of stages determined in advance, and generates augmentation data of a plurality of stages by an augmented sentence determined to be added. For example, when there is a word pair having a dependency relationship in an augmented sentence, and a degree of association of the word pair is less than or equal to a threshold of a certain stage, it is determined that the augmented sentence is not added to augmentation data of the stage, augmentation data of the stage is generated by an augmented sentence determined to be added. In this way, it is possible to appropriately generate augmentation data while considering a degree of association between words.

### Advantageous Effects of Invention

According to the disclosure, augmentation data can be appropriately generated while considering a degree of association between words.

### BRIEF DESCRIPTION OF DRAWINGS

FIG. 1 is a functional block configuration diagram of a training data augmentation device according to an embodiment of the invention.

FIG. 2 is a flow diagram illustrating processing executed in the training data augmentation device according to an embodiment of the invention.

FIG. 3 is a diagram for describing a function of an augmented sentence generator.

FIG. 4(a) is a diagram for describing a function of an augmentation data generator, FIG. 4(b) is a diagram illustrating a setting example of a threshold, and FIG. 4(c) is a diagram illustrating a processing example when threshold=0.

FIG. 5 is a diagram illustrating a flow of generation of an augmented sentence and generation of augmentation data.

FIG. 6 is a diagram for describing a function of a model accuracy deriver and a function of a data determiner.

FIG. 7 is a diagram illustrating a score derivation example using the model accuracy deriver.

FIG. 8 is a diagram illustrating a hardware configuration example of the training data augmentation device.

### DESCRIPTION OF EMBODIMENTS

Hereinafter, an embodiment of a training data augmentation device according to the disclosure will be described with reference to the drawings.

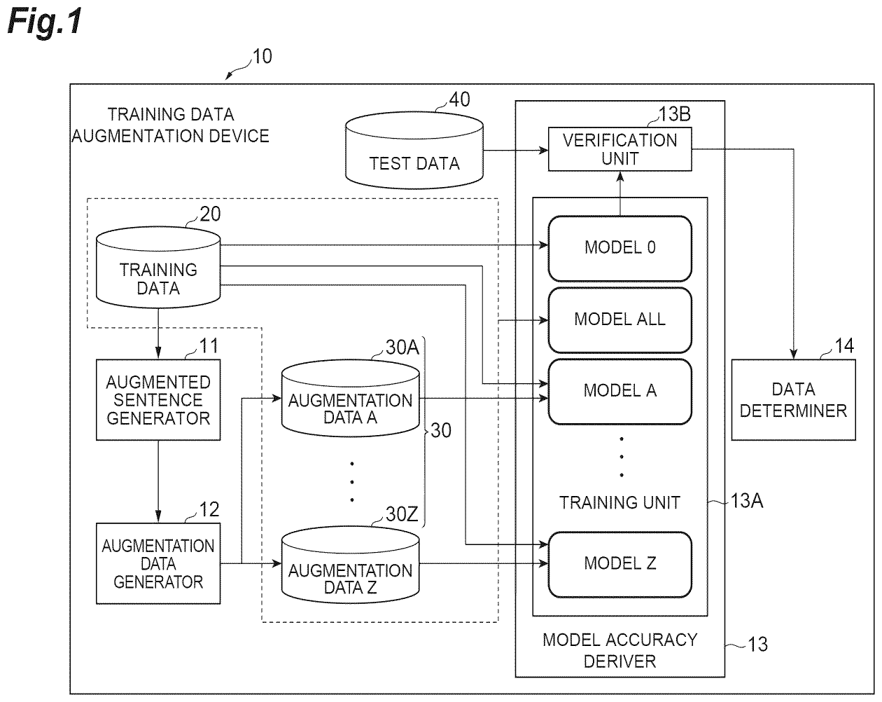

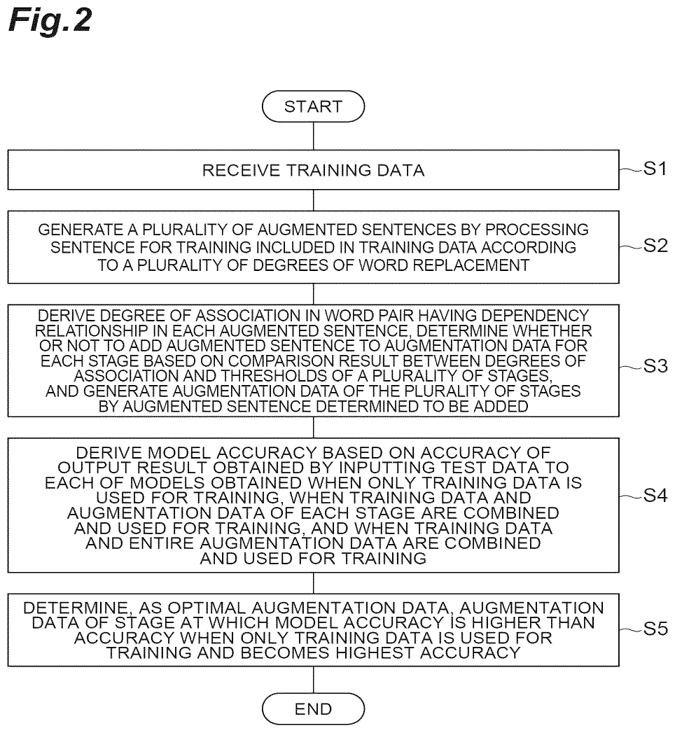

As illustrated in FIG. 1, the training data augmentation device 10 includes an augmented sentence generator 11, an augmentation data generator 12, a model accuracy deriver 13, and a data determiner 14. Functions of each of the units will be described below. However, detailed functions and processing contents will be described in detail later along with a flow diagram of FIG. 2.

The augmented sentence generator 11 is a functional unit that generates a plurality of augmented sentences by processing a sentence for training included in training data 20 given in advance according to a plurality of degrees of word replacement.

The augmentation data generator 12 is a functional unit that derives a degree of association in a word pair having a dependency relationship in each generated augmented sentence, determines at each stage whether or not to add the augmented sentence to augmentation data for augmenting training data based on a comparison result between the obtained degree of association and thresholds of a plurality of predetermined stages, and generates augmentation data A, B, . . . , Z (hereinafter collectively referred to as “augmentation data 30”) of a plurality of stages by the augmented sentence determined to be added.

The model accuracy deriver 13 is a functional unit that derives accuracy of each model based on accuracy of an output result obtained by inputting prepared test data 40 to each of models (model A to Z, model 0, etc. of FIG. 1) obtained when the training data 20 and the augmentation data 30 of each stage are combined and used for training, when only the training data 20 is used for training, etc. More specifically, the model accuracy deriver 13 includes a training unit 13A and a verification unit 13B, and the training unit 13A performs training using only the training data 20 to hold obtained model 0, performs training by combining and using the training data 20 and the augmentation data 30 of each stage to hold models A to 7, obtained therefrom, respectively, and performs training combining and using the training data 20 and the entire augmentation data 30 to hold obtained model ALL. The verification unit 13B inputs the test data 40 to each of the above-mentioned model 0, models A to Z, and model ALL held by the training unit 13A to obtain each output result, and derives accuracy of each model based on accuracy of each obtained output result. Note that the training unit 13A may perform training by combining and using two or more of pieces of the augmentation data 30 of each of the stages and the training data 20, and hold an obtained model. However, as a typical example of such a pattern, in this embodiment, a description is given of an example in which the training unit 13A performs training by combining and using the training data and the entire augmentation data.

The data determiner 14 is a functional unit that determines, as optimal augmentation data, augmentation data of a stage at which accuracy of a model is higher than accuracy when only the training data 20 is used for training (accuracy of model 0) and becomes highest accuracy. Note that various types of data such as the training data 20, the augmentation data 30, and the test data 40 illustrated in FIG. 1, and a PMI model 35 to be described later are stored in any memory of the training data augmentation device 10. However, it is not essential that the memory be inside the training data augmentation device 10, and an external memory of the training data augmentation device 10 may be used.

Next, processing executed in the training data augmentation device 10 will be described along a flowchart of FIG. 2.

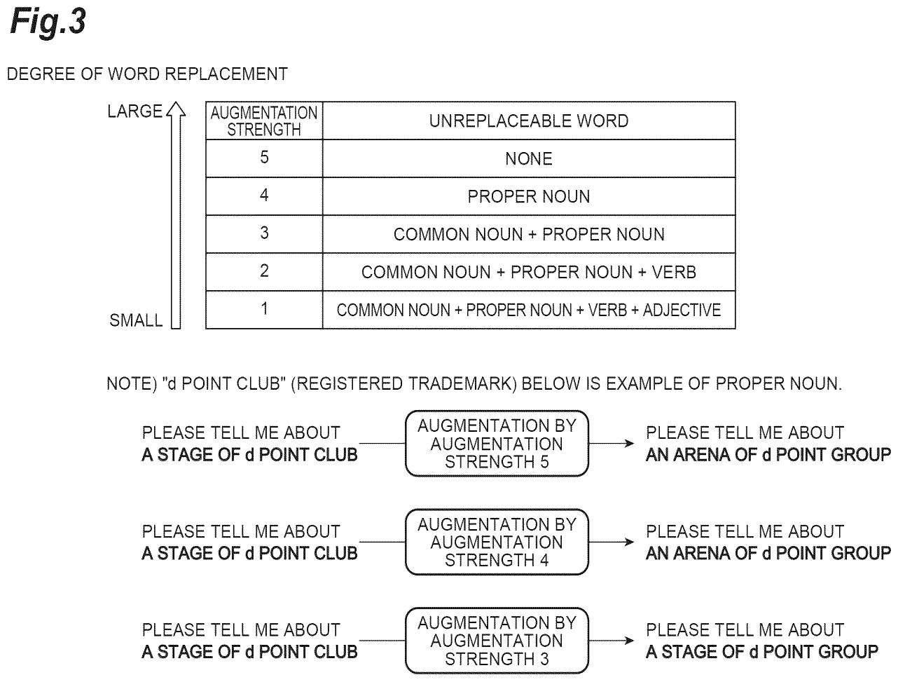

First, the augmented sentence generator 11 receives the training data 20 (step S1), and generates a plurality of augmented sentences by, for example, processing a sentence for training included in the training data 20 according to a plurality of degrees of word replacement as illustrated in FIG. 3 (step S2). In an example of FIG. 3, augmentation strengths 1 to 5 are predetermined in accordance with a plurality of degrees of word replacement (5 stages as an example). For example, augmentation strength 5 means that “there are no words that cannot be replaced”, and is a stage having a highest degree of word replacement in which all replaceable words are replaced. The degrees of word replacement are set to gradually decrease such that augmentation strength 4 is a stage in which “only a proper noun is not replaced”, and augmentation strength 3 is a stage in which “only a proper noun and a common noun are not replaced”.

A description will be given of an example in which a plurality of augmented sentences is generated by processing a sentence for training “Please tell me about a stage of d Point Club” including “d Point Club (registered trademark)” that is a proper noun and “stage” that is a common noun at each of augmentation strengths 3 to 5 according to the above-mentioned augmentation strengths. As illustrated in FIG. 3, in augmentation at augmentation strength 5, “there are no words that cannot be replaced”. Thus, the proper noun “d Point Club” is replaced with “d Point group”, the common noun “stage” is replaced with “arena”, and an augmented sentence “Please tell me about an arena of d Point group” is generated. In augmentation at augmentation strength 4, “only a proper noun is not replaced”. Thus, the proper noun “d Point Club” is not replaced, the common noun “stage” is replaced with “arena”, and an augmented sentence “Please tell me about an arena of d Point Club” is generated. Further, in augmentation at augmentation strength 3, “only a proper noun and a common noun are not replaced”. Thus, neither the proper noun “d Point Club” nor the common noun “stage” cannot be replaced. As a result, the same augmented sentence “Please tell me about a stage of d Point Club” as that before augmentation is generated.

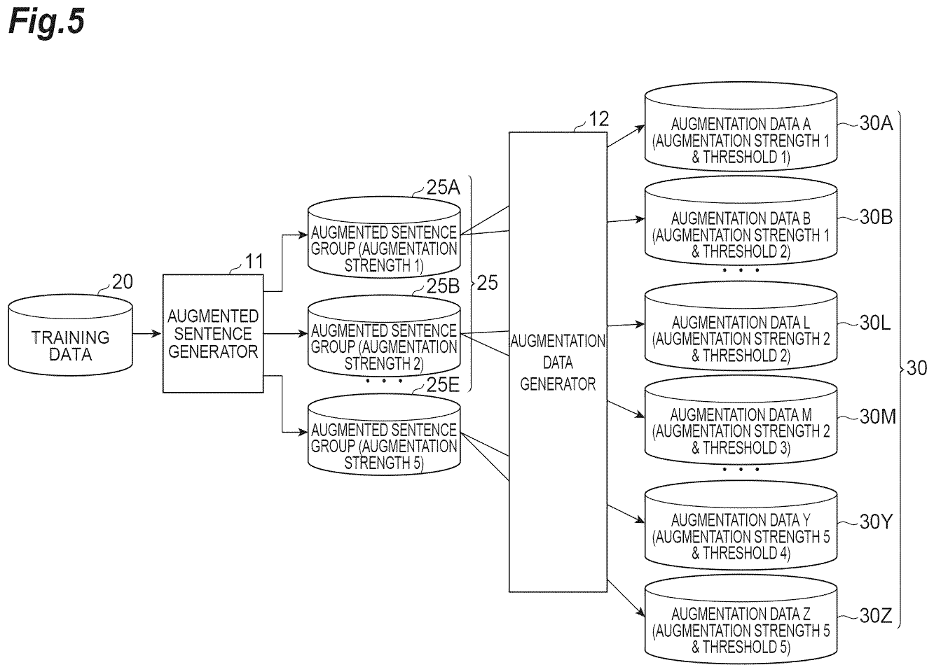

FIG. 5 illustrates a flow of generation of an augmented sentence and generation of augmentation data. As illustrated in FIG. 5, in step S2 of FIG. 2, the augmented sentence generator 11 generates an augmented sentence group 25A including a plurality of augmented sentences augmented at augmentation strength 1, an augmented sentence group 25B including a plurality of augmented sentences augmented at augmentation strength 2, an augmented sentence group 25C including a plurality of augmented sentences augmented at augmentation strength 3, an augmented sentence group 25D including a plurality of augmented sentences augmented at augmentation strength 4, and an augmented sentence group 25E including a plurality of augmented sentences augmented at augmentation strength 5 (note that these augmented sentence groups are collectively referred to as “augmented sentence group 25”), and transmits the augmented sentence group to the augmentation data generator 12.

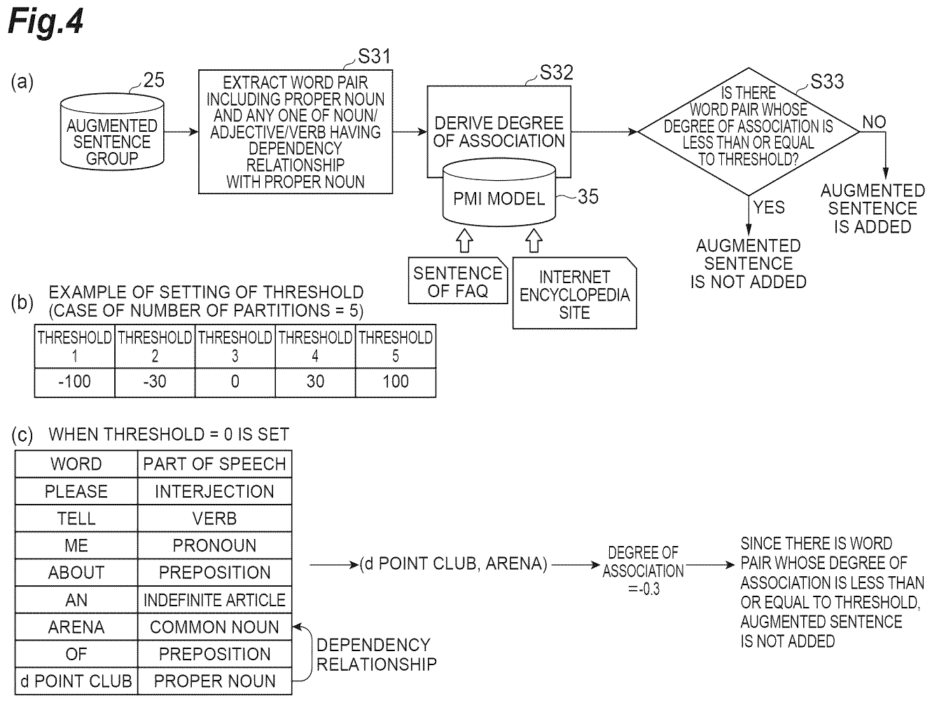

Returning to FIG. 2, in the next step S3, the augmentation data generator 12 derives a degree of association in a word pair having a dependency relationship in each augmented sentence, determines whether or not to add the augmented sentence to augmentation data for each stage based on a comparison result between a degree of association and thresholds of a plurality of stages, and generates augmentation data of a plurality of stages by an augmented sentence determined to be added. Here, for example, as illustrated in FIG. 4(a), the augmentation data generator 12 extracts a word pair including: a proper noun and any one of a noun, an adjective and a verb each having a dependency relationship with the proper noun from the augmented sentence group 25 (step S31), and derives a degree of association of the extracted word pair (step S32). Here, for example, point-wise mutual information (hereinafter referred to as “PMI”) is used as “degree of association”, and by inputting the word pair to the PMI model 35 obtained in advance by machine learning using a sentence of FAQ (Frequently Asked Questions), Internet encyclopedia site (Wikipedia (registered trademark)), etc., a degree of association of the word pair is derived as output thereof. Further, the augmentation data generator 12 compares the derived degree of association with each of the thresholds of the plurality of stages (step S33). Here, for example, when an augmented sentence includes a word pair whose degree of association is less than or equal to a threshold of a certain stage, it is determined that the augmented sentence is not added to augmentation data of the stage. Therefore, when there is a word pair whose degree of association is less than or equal to the threshold of the certain stage, the augmented sentence is not added to augmentation data of the stage. On the other hand, when there is no word pair whose degree of association is less than or equal to the threshold of the certain stage, the augmented sentence is added to augmentation data of the stage.

The PMI used as the “degree of association” in step S33 described above is a measure of a degree of association between a word pair (two words), and PMI (x, y) including a word x and a word y is defined as the following equation.

$$PMI ( x , y ) = {log}_{2} \frac{P ( x , y )}{P ( x ) P ( y )} \qquad [ Equation 1 ]$$

Where.
P(x, y): Probability that both words x and y appear
P(x): Probability that word x appears
P(y): Probability that word y appears
   For this reason, for example, when the degree of association PMI (x, y) of the word pair including the word x and the word y is derived in a document having a total number of words of 10000, if the word x appears 120 times, the word y appears 40 times, and both the word x and the word y appear 20 times in the document, the degree of association PMI (x, y) is derived as follows.

$$PMI ( x , y ) = {log}_{2} \frac{\frac{20}{10000}}{\frac{120}{10000} * \frac{40}{10000}} = {log}_{2} \frac{20 * 10000}{120 * 40} \approx 3.28 \qquad [ Equation 2 ]$$

Further, as the “threshold” used in the above step S33, for example, “threshold 1”, “threshold 2”, . . . , “threshold 5” whose number of partitions is 5 and whose values are set to values illustrated in FIG. 4(b) are used. In addition, as illustrated in FIG. 4(c), when “threshold 3 (value is “0”)” of FIG. 4(b) is used as a threshold, if a degree of association “−0.3” is derived for a word pair including a proper noun “d Point Club” and a noun “arena” having a dependency relationship with the proper noun, an augmented sentence subjected to determination includes a word pair (d Point Club, arena) whose degree of association is less than or equal to the threshold, and thus it is determined that the augmented sentence is not added.

Through processing of step S3 of FIG. 2 described above, as illustrated in FIG. 5, “determining whether to add an augmented sentence” using five stages of thresholds 1 to 5 is performed for each of the augmented sentence groups 25A, 25B, . . . , 25E. Note that, for convenience, FIG. 5 illustrates some of 25 types of augmentation data 30 described above, that is, augmentation data 30A generated using augmentation strength 1 and threshold 1, augmentation data 30B generated using augmentation strength 1 and threshold 2, augmentation data 30L generated using augmentation strength 2 and threshold 2, augmentation data 30M generated using augmentation strength 2 and threshold 3, augmentation data 30Y generated using augmentation strength 5 and threshold 4, and augmentation data 30Z generated using augmentation strength 5 and threshold 5.

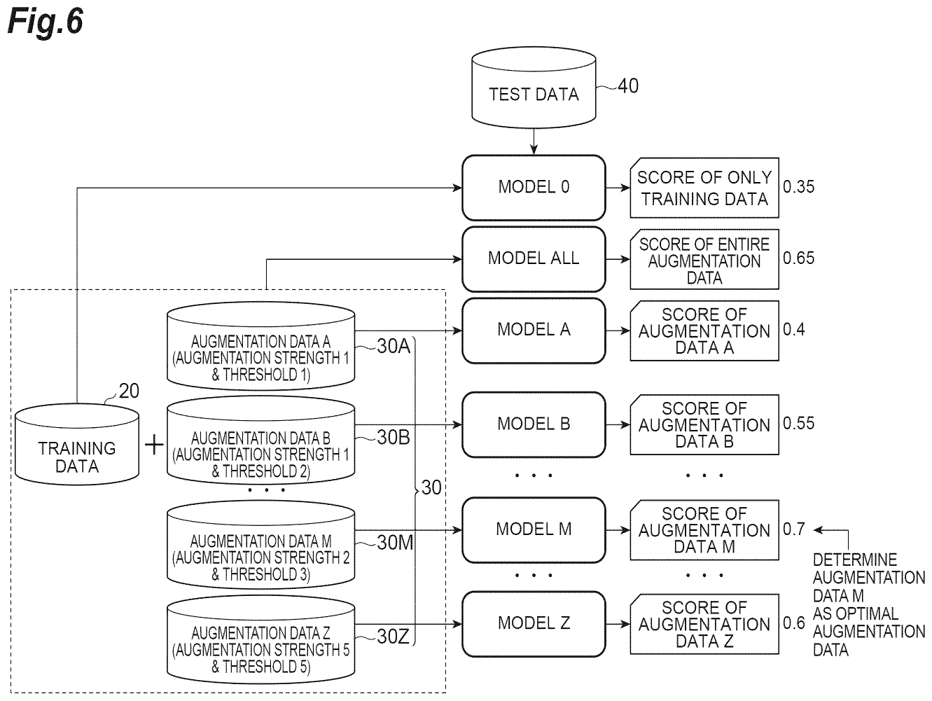

Returning to FIG. 2, in the next step S4, the model accuracy deriver 13 derives model accuracy based on accuracy of an output result obtained by inputting the prepared test data 40 to each of models obtained (1) when only the training data 20 is used for training, (2) when the training data 20 and the augmentation data 30 of each stage are combined and used for training, and (3) when the training data 20 and the entire augmentation data 30 are combined and used for training (step S4). In more detail, for example, as illustrated in FIG. 6, first, the model accuracy deriver 13 acquires model 0 by using only the training data 20 for training, acquires models A to Z by combining the training data 20 and the augmentation data 30 of each stage (that is, by combining the training data 20 and augmentation data A, by combining the training data 20 and augmentation data B, . . . , by combining the training data 20 and augmentation data Z) and using the combined data for training, and acquires model ALL by combining the training data 20 and the entire augmentation data 30 and using the combined data for training. Then, the model accuracy deriver 13 obtains an output result for each model by inputting the test data 40 to each of acquired model 0, model ALL, and models A to Z, and derives accuracy of the model, for example, as follows based on the obtained output result for each model.

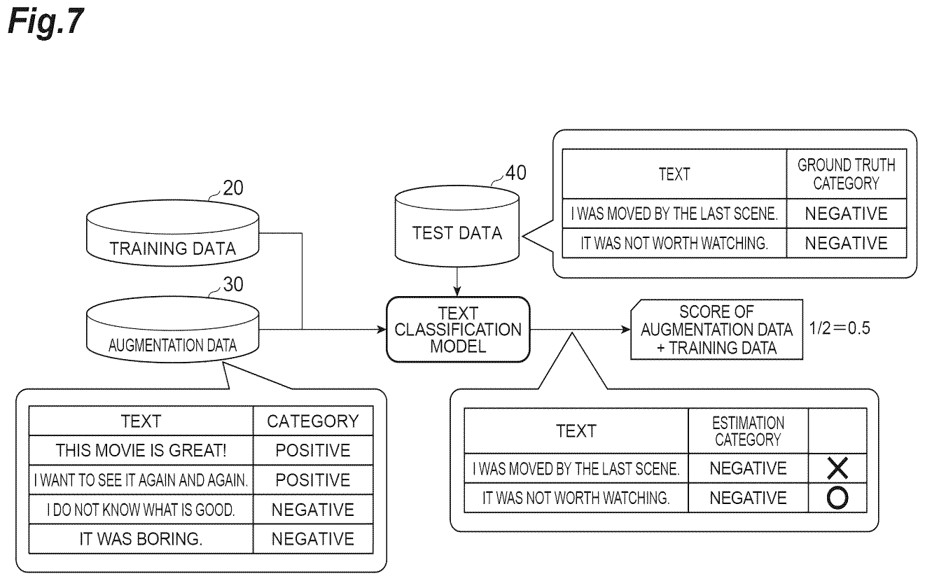

Here, as illustrated in FIG. 7, when assuming a text classification model for classifying movie reviews as positive or negative contents, a classification accuracy score is derived as model accuracy (denoted as “score” in FIGS. 6 and 7). It is assumed that, when “text” in the text data 40 is input to the text classification model obtained by combining the training data 20 and the augmentation data 30 illustrated in FIG. 7 and using the combined data for training, a result estimated to be “negative” is obtained for a text sentence “I was moved by the last scene.” and a result estimated to be “negative” is also obtained for a text sentence “It was not worth watching”. In this case, when compared with ground truth categories of test data, the text sentence “It was not worth watching” is correct, whereas the text sentence “I was moved by the last scene.” is incorrect. Therefore, one time out of two times of classification is ground truth, and a classification accuracy score 0.5 is derived as accuracy of the model.

Returning to FIG. 2, in the next step S5, the data determiner 14 determines, as optimal augmentation data, augmentation data of a stage at which model accuracy is higher than accuracy when only training data is used for training and becomes the highest accuracy (step S5). In the example of FIG. 6, a score “0.7” of augmentation data M is higher than accuracy “0.35” when only training data is used for training and becomes the highest accuracy, and thus the augmentation data M is determined as the optimal augmentation data. Thereafter, for example, data obtained by augmenting the training data 20 using the augmentation data M considered to be the optimal augmentation data is appropriately used as data in place of the training data 20 or additional data with respect to the training data 20.

Note that, in step S5, when there is a plurality of pieces of augmentation data of a stage at which model accuracy is higher than accuracy when only the training data 20 is used for training and becomes the highest accuracy, the plurality of pieces of augmentation data may be determined as optimal augmentation data, or one piece of augmentation data selected from the plurality of pieces of augmentation data using any method may be determined as optimal augmentation data. In addition, if accuracy when only the training data 20 is used for training becomes the highest, it can be determined that optimal augmentation data is not present, and thus determination of optimal augmentation data is avoided.

According to the embodiment described above, through processing of steps S2 and S3 of FIG. 2, while considering a degree of association between words in a word pair, it is possible to appropriately generate the augmentation data 30A, 30B, . . . , 30Z of the plurality of stages for selecting augmentation data related to an appropriate degree of association. Along therewith, when the training data includes a plurality of sentences expressed in a certain language, it is possible to reduce the cost of generating the augmentation data, and it is possible to flexibly respond to changes in a degree of augmentation of a word depending on the context.

In addition, by using PMI which is highly reliable and widely and generally used in linguistic data, as a “degree of association” between words in a word pair, it is possible to appropriately generate the augmentation data 30A, 30B, . . . , 30Z of the plurality of stages based on the appropriate “degree of association”.

In addition, the augmentation data generator 12 can derive an appropriate degree of association after giving importance to a dependency relationship between a proper noun and another word by setting a word pair including: a proper noun; and any one of a noun, an adjective and a verb each having a dependency relationship with the proper noun, as a target for deriving the degree of association in the word pair having the dependency relationship.

In addition, for an augmented sentence including a plurality of word pairs each having a dependency relationship, when there is a word pair whose degree of association is less than or equal to a threshold of a certain stage among the plurality of word pairs, the augmentation data generator 12 determines not to add the augmented sentence to augmentation data of the stage (step S33 of FIG. 4(a)). In this way, when there is even one word pair whose degree of association is less than or equal to the threshold, it is possible to avoid adding the corresponding augmented sentence to the augmentation data of the corresponding stage, and to avoid adding an inappropriate augmented sentence on a safer side.

In addition, instead of the above description, for an augmented sentence including a plurality of word pairs each having a dependency relationship, when all degrees of association of the plurality of word pairs are less than or equal to a threshold of a certain stage, the augmentation data generator 12 may determine not to add the augmented sentence to augmentation data of the corresponding stage. In this case, it is possible to actively promote addition of augmented sentences to augmentation data while avoiding addition of an augmented sentence in which degrees of association of all included word pairs are less than or equal to the threshold.

Further, through processing of steps S4 and S5 of FIG. 2, the model accuracy deriver 13 derives accuracy (score) of each model based on accuracy of an output result obtained by inputting the test data 40 to each of models obtained (1) when only the training data 20 is used for training, (2) when the training data 20 and the augmentation data 30 of each stage are combined and used for training, and (3) when the training data 20 and the entire augmentation data 30 are combined and used for training, and determines, as optimal augmentation data, augmentation data of a stage at which accuracy of the model is higher than accuracy when only the training data is used for training and becomes the highest accuracy. In this way, it becomes possible to realize augmentation of training data using optimal augmentation data rather than simple augmentation of training data. In this case, it is unnecessary to target the model obtained in the above-mentioned case of (3), and it is possible to realize augmentation of training data using optimal augmentation data even without requiring the above-mentioned case of (3).

It is obvious that the model accuracy deriver 13 may derive accuracy (score) of each model further based on accuracy of an output result obtained by inputting the test data 40 to a model obtained when two or more pieces of the augmentation data 30 of each stage and the training data 20 are combined and used for training, which can target, for example, a plurality of models obtained from further combination patterns such as “training data 20+augmentation data A+augmentation data B”, “training data 20+augmentation data A+augmentation data M” and “training data 20+augmentation data A+augmentation data Z” while including the above-mentioned case of (3), and optimal augmentation data can be determined from a wider range of augmentation data candidates.

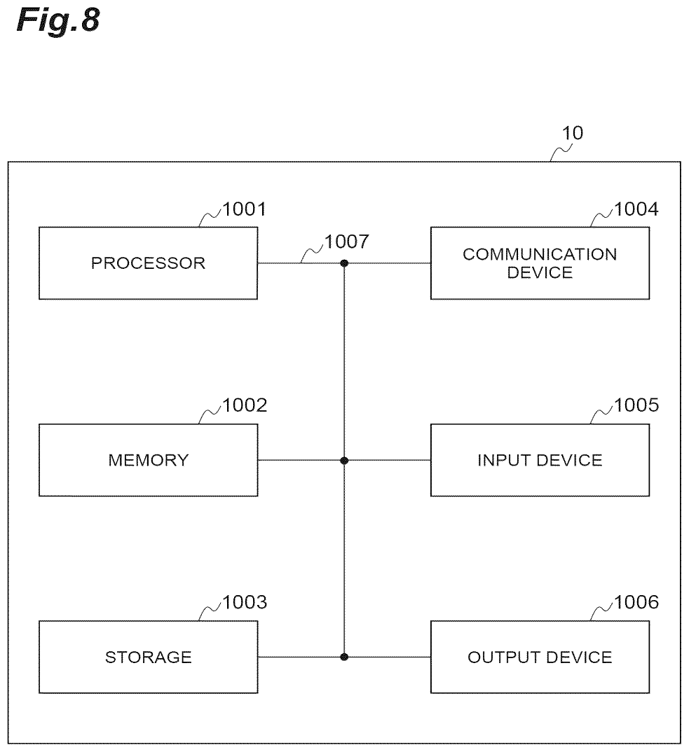

### (Description of Terms, Description of Hardware Configuration (FIG. 8), etc.)

Note that block diagrams used for description of the embodiments and modifications illustrate blocks in functional units. These functional blocks (components) are realized by any combination of at least one of hardware and software. Furthermore, a method of realizing each functional block is not particularly limited. That is, each functional block may be realized using one physically or logically coupled device, or may be realized by directly or indirectly (for example, by wire, wirelessly, etc.) connecting two or more physically or logically separated devices and using a plurality of these devices. The functional block may be realized by combining software with the one device or the plurality of devices.

Functions include determining, deciding, judging, calculating, computing, processing, deriving, investigating, searching, verifying, receiving, transmitting, outputting, accessing, solving, selecting, choosing, establishing, comparing, assuming, expecting, considering, broadcasting, notifying, communicating, forwarding, configuring, reconfiguring, allocating, mapping, assigning, etc. However, the invention is not limited thereto. For example, a functional block (configuration unit) that performs transmission is referred to as a transmitting unit or a transmitter. In either case, as described above, the method of realizing is not particularly limited.

For example, the training data augmentation device in an embodiment of the disclosure may function as a computer that performs processing in this embodiment. FIG. 8 is a diagram illustrating an example of a hardware configuration of the training data augmentation device 10 according to an embodiment of the disclosure. The training data augmentation device 10 may be physically configured as a computer device including a processor 1001, a memory 1002, a storage 1003, a communication device 1004, an input device 1005, an output device 1006, a bus 1007, etc.

Note that, in the following description, the word “device” can be interpreted as a circuit, an apparatus, a unit, etc. The hardware configuration of the training data augmentation device 10 may include one or more of devices, each of which is illustrated in the figure, or may not include some of the devices.

Each function of the training data augmentation device 10 is realized by loading predetermined software (program) onto hardware such as the processor 1001 and the memory 1002 so that the processor 1001 performs arithmetic operation, controlling communication by the communication device 1004, and controlling at least one of reading and writing of data in the memory 1002 and the storage 1003.

For example, the processor 1001 operates an operating system to control the entire computer. The processor 1001 may be configured as a central processing unit (CPU) including an interface with peripheral devices, a control device, an operation device, a register, etc.

Furthermore, the processor 1001 reads a program (program code), a software module, data, etc. from the storage 1003 and/or the communication device 1004 to the memory 1002, and executes various processes in accordance therewith. A program that causes a computer to execute at least part of the operation described in the embodiment is used as the program. Even though the above-described various processes have been described as being executed by one processor 1001, the processes may be executed by two or more processors 1001 simultaneously or sequentially. The processor 1001 may be implemented with one or more chips. Note that the program may be transmitted from a network via a telecommunications line.

The memory 1002 is a computer-readable recording medium, and may include, for example, at least one of a ROM (Read Only Memory), an EPROM (Erasable Programmable ROM), an EEPROM (Electrically Erasable Programmable ROM), a RAM (Random Access Memory), etc. The memory 1002 may be referred to as a register, a cache, a main memory (main storage device), etc. The memory 1002 can store an executable program (program code), a software module, etc. for implementing a wireless communication method according to an embodiment of the disclosure.

The storage 1003 is a computer-readable recording medium, and may include, for example, at least one of an optical disc such as a CD-ROM (Compact Disc ROM), a hard disk drive, a flexible disk, a magneto-optical disk (for example, a compact disk, a digital versatile disk, or a Blu-ray (registered trademark disk) disk), a smart card, a flash memory (for example, a card, a stick, or a key drive), a floppy (registered trademark disk) disk, a magnetic strip, etc. The storage 1003 may be referred to as an auxiliary storage device. The above-mentioned storage medium may be, for example, a database including at least one of the memory 1002 and the storage 1003, or another suitable medium.

The communication device 1004 is hardware (transmission/reception apparatus) for communication with a computer via at least one of a wired network and a wireless network, and is also referred to as, for example, a network apparatus, a network controller, a network card, a communication module, etc.

The input device 1005 is an input apparatus (for example, a keyboard, a mouse, a microphone, a switch, a button, a sensor, etc.) that receives input from the outside. The output device 1006 is an output apparatus (for example, a display, a speaker, an LED lamp, etc.) that performs output to the outside. Note that the input device 1005 and the output device 1006 may have an integrated configuration (for example, a touch panel). Furthermore, each device such as the processor 1001 or the memory 1002 is connected by the bus 1007 for information communication. The bus 1007 may be configured using a single bus or may be configured using buses different between devices.

Each aspect/embodiment described in the disclosure may be used alone, may be used in combination, or may be switched and used in accordance with execution. In addition, notification of predetermined information (for example, notification of “being X”) is not limited to being explicitly performed, but may also be implicitly performed (for example, notification of the predetermined information is not performed).

Even though the disclosure has been described in detail above, it is clear to those skilled in the art that the disclosure is not limited to the embodiment described in the disclosure. The disclosure can be implemented as modifications and changes without departing from the spirit and scope of the disclosure as defined by the claims. Therefore, the description of the disclosure is for the purpose of illustrative description and does not have any restrictive meaning with respect to the disclosure.

The order of processing procedures, sequences, flowcharts, etc. of each aspect/embodiment described in the disclosure may be changed as long as there is no contradiction. For example, with regard to the method described in the disclosure, elements of various steps are presented using an illustrative order, and the method is not limited to the presented specific order.

Input/output information, etc. may be stored in a specific location (for example, a memory) or may be managed using a management table. The input/output information, etc. can be overwritten, updated, or additionally written. The output information, etc. may be deleted. The input information, etc. may be transmitted to another device.

As used in the disclosure, the phrase “based on” does not mean “based only on” unless expressly stated otherwise. In other words, the phrase “based on” means both “based only on” and “based at least on”.

In the disclosure, when “include”, “including”, and variations thereof are used, these terms are intended to be inclusive as a term “comprising”. Furthermore, a term “or” used in the disclosure is not intended to be exclusive OR.

In the disclosure, for example, when articles are added by translation, such as “a”, “an”, and “the” in English, the disclosure may include that nouns following these articles are plural.

In the present disclosure, the term “A and B are different” may mean “A and B are different from each other”. Note that the term may also mean that “A and B are each different from C”. Terms such as “separated” and “coupled” may also be interpreted similarly to “different”.

### REFERENCE SIGNS LIST

10: training data augmentation device, 11: augmented sentence generator, 12: augmentation data generator, 13: model accuracy deriver, 13A: training unit, 13B: verification unit, 14: data determiner, 20: training data, 25: augmented sentence group, 30: augmentation data, 35: PMI model, 40: test data, 1001: processor, 1002: memory, 1003: storage, 1004: communication device, 1005: input device, 1006: output device, 1007: bus.

1. A training data augmentation device comprising:
an augmented sentence generator configured to generate a plurality of augmented sentences by processing a sentence for training included in training data given in advance according to a plurality of degrees of word replacement; and
an augmentation data generator configured to derive a degree of association in a word pair having a dependency relationship in each augmented sentence, determine whether or not to add the augmented sentence to augmentation data for augmenting the training data for each stage based on a comparison result between an obtained degree of association and thresholds of a plurality of stages determined in advance, and generate augmentation data of a plurality of stages by an augmented sentence determined to be added.

2. The training data augmentation device according to claim 1, wherein the augmentation data generator uses a point-wise mutual information as the degree of association.

3. The training data augmentation device according to claim 1, wherein the augmentation data generator sets a word pair including:
a proper noun; and
any one of a noun, an adjective and a verb, each having a dependency relationship with the proper noun,
as a target for deriving the degree of association in the word pair having the dependency relationship.

4. The training data augmentation device according to claim 1, wherein, for an augmented sentence including a plurality of word pairs each having a dependency relationship, when there is a word pair whose degree of association is less than or equal to a threshold of a certain stage among the plurality of word pairs, the augmentation data generator determines not to add the augmented sentence to augmentation data of the stage.

5. The training data augmentation device according to claim 1, wherein, for an augmented sentence including a plurality of word pairs each having a dependency relationship, when all degrees of association in the plurality of word pairs are less than or equal to a threshold of a certain stage, the augmentation data generator determines not to add the augmented sentence to augmentation data of the stage.

6. The training data augmentation device according to claim 1, further comprising:
a model accuracy deriver configured to derive accuracy of each of models obtained when the training data and augmentation data of each of stages are combined and used for training and when the training data is exclusively used for training, based on accuracy of an output result obtained by inputting predetermined test data to each of the models; and
a data determiner configured to determine, as optimal augmentation data, augmentation data of a stage at which the accuracy of the model is higher than the accuracy when the training data is exclusively used for training and becomes highest accuracy.

7. The training data augmentation device according to claim 6, wherein the model accuracy deriver derives the accuracy of the model, on a further basis of accuracy of an output result obtained by inputting predetermined test data to a model obtained when the training data and at least two pieces of augmentation data of each of the stages are combined and used for training.

8. The training data augmentation device according to claim 2, wherein the augmentation data generator sets a word pair including:
a proper noun; and
any one of a noun, an adjective and a verb, each having a dependency relationship with the proper noun,
as a target for deriving the degree of association in the word pair having the dependency relationship.
